(19) United States
(12) Patent Application Publication
(10) Pub. No.: US 2009/0291730 A1
(43) Pub. Date: Nov. 26, 2009

(54) METHOD AND SYSTEM FOR PARIMUTUEL WAGERING ON OUTCOMES

(76) Inventor: John M. Aaron, Hickory Hills, IL (US)

Correspondence Address: CARDINAL LAW GROUP, SUITE 2000, 1603 ORRINGTON AVENUE, EVANSTON, IL, 60201, US

(21) Appl. No.: 12/124,702

(22) Filed: May 21, 2008

(51) Int. Cl. A63F 9/24; G06F 17/00

(52) U.S. Cl. 463/16; 463/43; 463/28

(57) ABSTRACT

A method for determining an award for at least one winner includes establishing at least a first outcome predicated on a common output produced by a plurality of entities working in conjunction, and establishing at least three scenarios associated with the first outcome, each scenario associated with a condition of the first outcome, and receiving a plurality of wagers associated with each scenario and at least one of the entities. The method further includes awarding at least a first award in a parimutuel basis based on the received wagers.

### FIELD OF THE INVENTION

The present invention relates to parimutuel wagering on outcomes.

### BACKGROUND OF THE INVENTION

It is difficult to accurately and profitably manage large scale projects. Aside from issues of scale, the persons with the most knowledge of what is needed to accomplish project goals are often implementation workers with limited ability to affect project operations. While implementation workers may express their concerns or needs to immediate supervisors, it is common that as project difficulties mount, supervisors may become reticent to accurately report to their supervisors, and senior management may have limited knowledge of the problems faced by those ‘in the field’. The famous ‘emperor's new clothes’ fairy tale can often prove prophetic. Thus, senior management has a pressing need to know and understand project difficulties, but is often ill-sited to receive the information that is needed. Other times, the children's game of ‘operator’ in which the same word is whispered down a chain can be an apt metaphor for management communication, as each time the message is relayed, its accuracy is reduced.

Prediction markets are often found to be accurate predictors of future occurrences. However, prediction markets are less effective if first-hand participation in the predicted outcome is unrewarded. Additionally, prediction markets function wherein the predictors have limited effects on the activity subject to prediction. For example, political events are often the subject of prediction markets, but each participant in the market has a somewhat limited effect on the outcome of the election. In contrast, a prediction market for project management could be severely compromised by internal saboteurs seeking to adversely affect the project for their own gain.

Additionally, extreme outcomes are often more likely than perceived. In general people tend to under-estimate extreme outcomes (risks). Often managers can tend to be more certain about things than might be prudent, and traditional risk identification processes could be made more accurate and efficient. On surveys respondents tend to cluster in the middle of a scale, so methods that might open up their thinking about risk could lead to better articulation of extreme possibilities of outcomes.

Similarly, parimutuel betting is highly advantageous for outcomes with uncertain odds, and is highly popular in, for example, horse racing. The high odds for extreme responses for parimutuel wagering takes advantage of people's risk taking behavior. However, parimutuel wagering is at a disadvantage when a participant in the outcome can affect the outcome.

Thus, what is needed is a method to ensure that senior management receives good predictive information regarding progress on a project, while rewarding the participants in the project for the quality of their insight. It is desirable to advance the art.

### SUMMARY OF THE INVENTION

A first embodiment includes a method for determining an award for at least one winner that includes establishing at least a first outcome predicated on a common output produced by a plurality of entities working in conjunction, and establishing at least three scenarios associated with the first outcome, each scenario associated with a condition of the first outcome, and receiving a plurality of wagers associated with each scenario and at least one of the entities. The method further includes awarding at least a first award in a parimutuel basis based on the received wagers.

Another embodiment includes a computer readable medium including computer readable code for determining an award for at least one winner that includes computer readable code for establishing at least a first outcome predicated on a common output produced by a plurality of entities working in conjunction, and computer readable code for establishing at least three scenarios associated with the first outcome, each scenario associated with a condition of the first outcome. The medium further includes computer readable code for receiving a plurality of wagers associated with each scenario and at least one of the entities, and computer readable code for awarding at least a first award in a parimutuel basis based on the received wagers.

Another embodiment includes a system for determining an award for at least one winner that includes means for establishing at least a first outcome predicated on a common output produced by a plurality of entities working in conjunction, and means for establishing at least three scenarios associated with the first outcome, each scenario associated with a condition of the first outcome. The system further includes means for receiving a plurality of wagers associated with each scenario and at least one of the entities, and means for awarding at least a first award in a parimutuel basis based on the received wagers.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIGS. 1-4 illustrate methods of determining an award for at least one winner, in accordance with various aspects of the invention;

FIG. 5 illustrates exemplary scenarios associated with an outcome, in accordance with an aspect of the invention;

FIG. 6 illustrates an inflection point, in accordance with an aspect of the invention; and

FIG. 7 illustrates a risk mitigation curve, in accordance with an aspect of the invention.

### DETAILED DESCRIPTION OF THE INVENTION

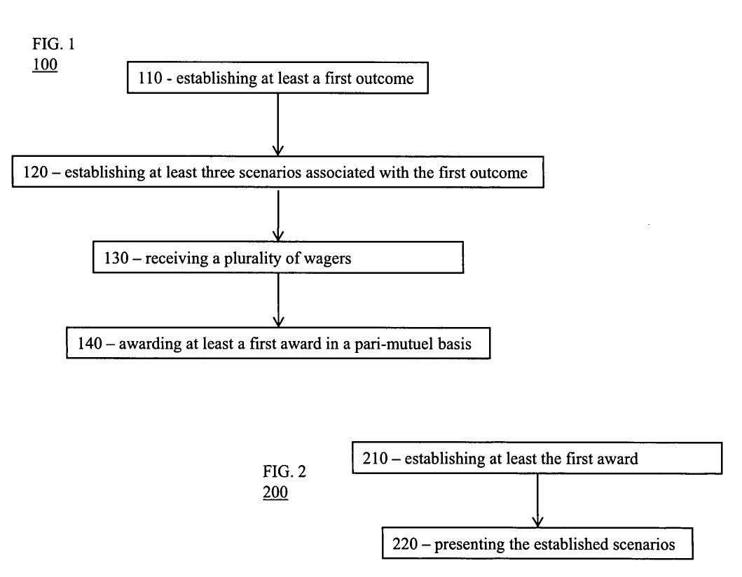

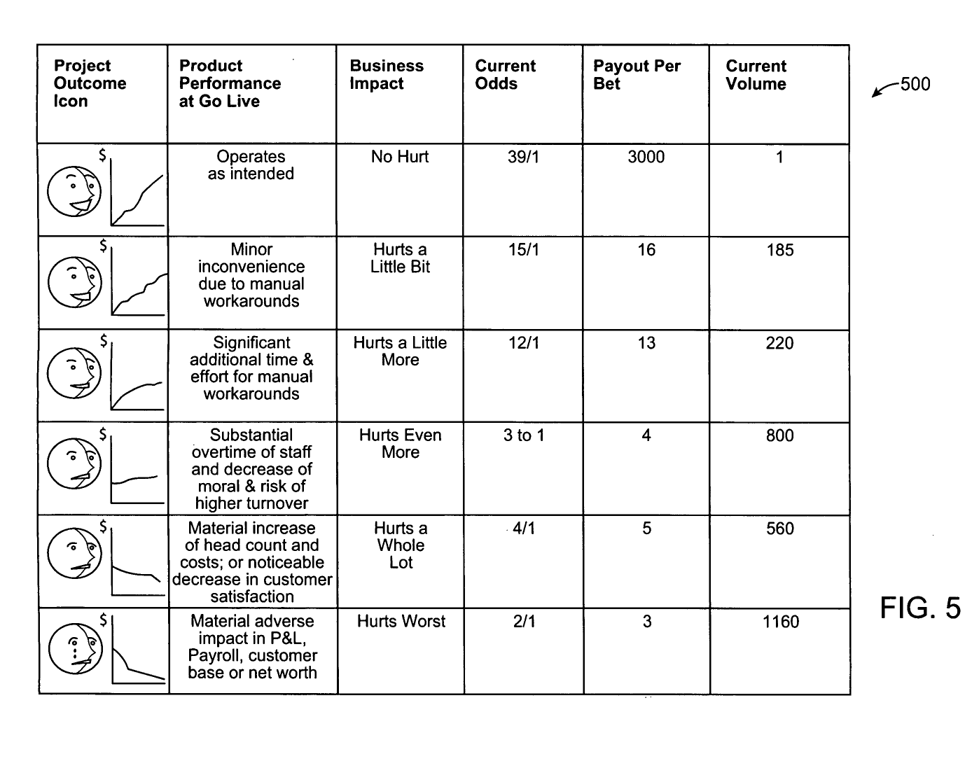

FIG. 1 illustrates a flowchart of a method 100 for determining an award for at least one winner, in accordance with one aspect of the invention. Method 100 includes establishing at least a first outcome, at step 110. The first outcome is predicated on a common output produced by a plurality of entities working in conjunction. In one embodiment, the outcome relates to a project, and each of the plurality of entities is working on at least a portion of the project. Each entity can be an individual, a company, or an association of individuals working as a team for a common goal as a portion of the project. The project can be any project, such as, but not limited to, software implementation, software coding, or the like. At step 120, at least three scenarios are established, such that each scenario is associated with a condition of the first outcome. Each scenario relates to the outcome and describes a potential condition of the outcome. For example, in a three scenario situation, the scenarios could be “project complete, on time, on budget;” “project complete, on time, over budget;” and “project incomplete.” In another example, with six scenarios, the scenarios could include “operates as intended;” “minor inconvenience due to manual workarounds;” “significant additional time and effort for manual workarounds;” “substantial overtime of staff and decrease of morale with risk of high turnover;” “material increase of headcount and costs and decrease in customer satisfaction;” and “material adverse impact on P&L, payroll, customer base, or net worth.” The scenarios chosen for each project will vary depending on metrics to be measured and can vary by project. An exemplary chart 500 illustrating six scenarios is seen at FIG. 5. Each scenario may be associated with a graphical icon, such as the happy/sad faces illustrated in FIG. 5. Other graphical icons may also be used, and are within the scope of this disclosure.

At step 130, method 100 receives a plurality of wagers associated with each scenario and at least one of the entities. Each entity may be allowed to place a single wager, or each entity may be allotted a plurality of wagering units, W, wherein W≧2, and allowed to place any number of wagers B, wherein B≦W on any number of scenarios, S, such that S≦N, wherein N is the number of scenarios. Thus, each participant can wager each of their wagering units on a single scenario, or they may wager a portion of their allotted wagering units on different scenarios. Once the outcome is determined and classified according to the scenario, at least a first award is awarded in a parimutuel basis based on the received wagers based on the actual outcome at step 140. Each wagering unit may be financial or represent an abstract value, such as a point.

FIG. 2 illustrates an embodiment of a method for establishing the scenarios at 200. Method 200 includes establishing at least the first award associated with the first outcome at step 210. The first award can be any item perceived to be of value by the entities. The first award can be financial or nonfinancial. For example, the first award could be monetary. In another example, the first award could be a catered lunch for the winner. In another example, a trophy could be awarded. In another example, additional vacation days are the first award. Having determined the first award, at step 220, the established scenarios are presented to the entities.

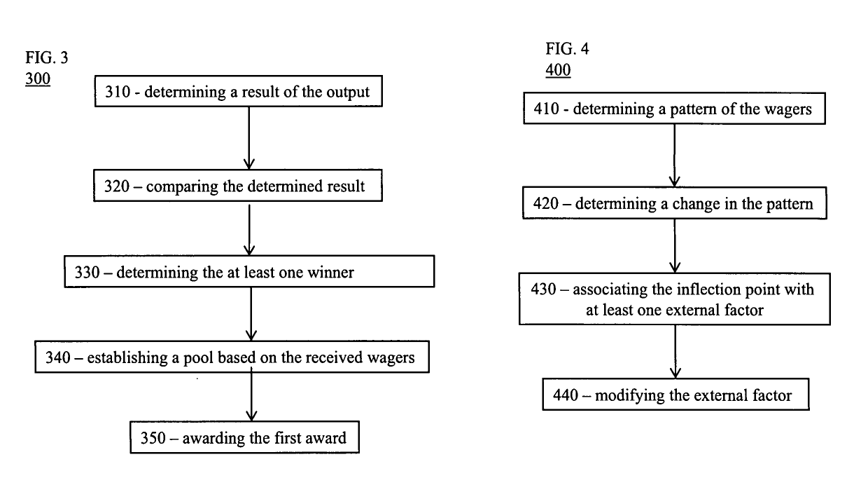

FIG. 3 illustrates one embodiment of a method 300 for awarding the first award, in accordance with one aspect of the invention. Method 300 begins at 310 by determining a result of the output. In one embodiment, the result of the output is determined and compared with the scenarios to determine which scenario is best representative of the output. The determined result is compared with the received wagers at step 320, and at least one winner is determined from the entities based on the comparison and the sum of the values associated with the winning wager. Based on the received wagers, a pool is established at step 330, and the first award is made to the determined winner based on the pool at step 340. The pool and payouts are made in traditional parimutuel fashion.

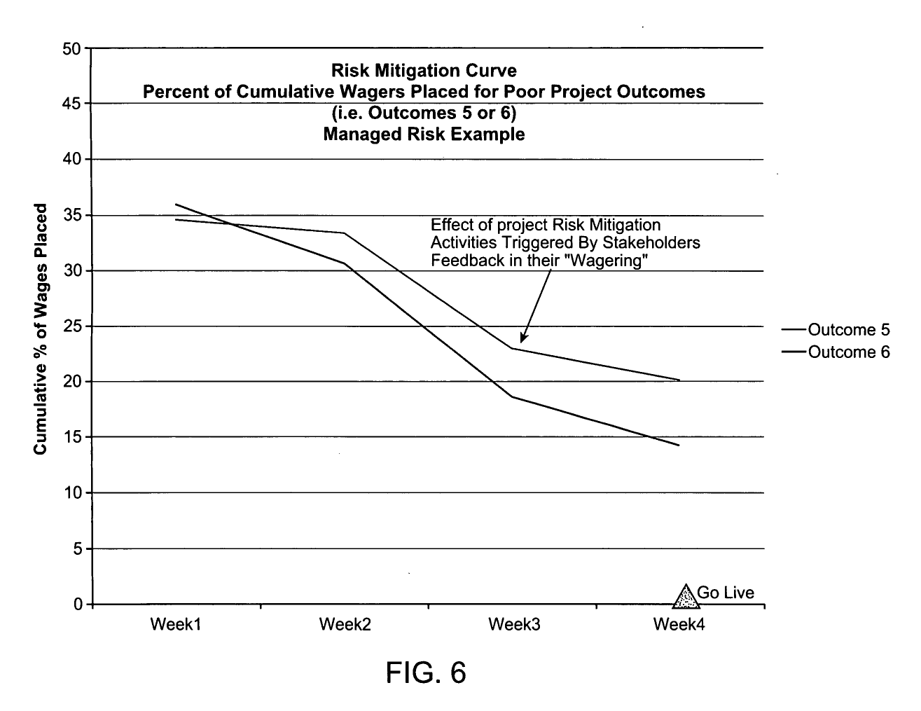

FIG. 4 illustrates a flowchart of a method 400 for receiving a plurality of wagers associated with each scenario and at least one of the entities in accordance with one aspect of the invention. Method 400 begins by determining a pattern of the wagers at step 410. The pattern, in one example, can be charted or graphed to present a visual cue illustrating the beliefs of the participants in the project. An exemplary graph is shown at FIG. 6. FIG. 6 illustrates a sample of a limited chart illustrating only negative views on the project, and the information determined by determining the pattern can be presented in any number of ways. In one embodiment, wagering occurs over a period of time and a pattern of wagering can be determined based on varying wager behavior over the period of time.

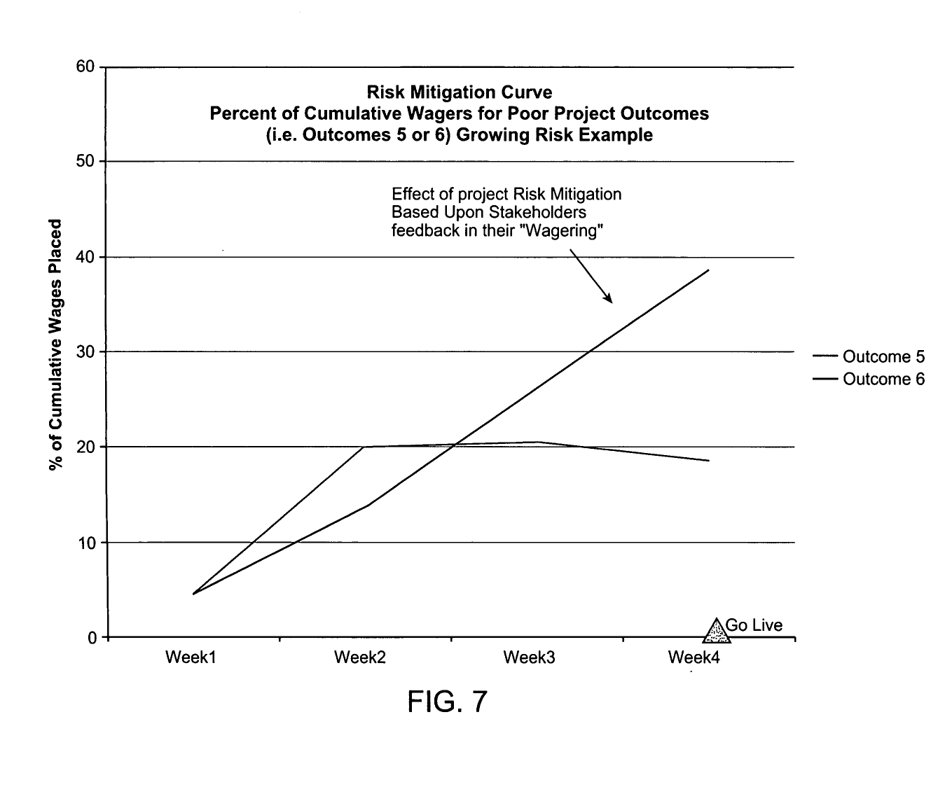

At step 420, method 400 determines a change in the pattern, wherein the change includes at least one inflection point. An example of a pattern change is illustrated in FIG. 7, as compared to FIG. 6. The inflection point is then associated with at least one external factor at step 430. For example, a change in staffing (an example of an external factor) can affect progress, either positively or negatively, and this may be reflected in a variance in the pattern of wagering. Other examples of external factors include budget modifications, modifications to project goals and/or deliverables, changes in morale factors (raises/cuts in per diem allowances, modified travel policies, etc.). Depending on the determined external factor, if the external factor is subject to management control, at step 440, the external factor is modified based on the inflection point. In one embodiment, the determined change can be associated with statements received from at least one wagering entity. For example, management notices an inflection point in the wagering pattern and seeks to determine the existence and/or identity of any external factors affecting the wagering pattern. In one embodiment, the inflection point is determined statistically, and a notification is automatically generated (such as an email or other alert) and transmitted to an appropriate person.

Additionally, these methods can be iterative, with each outcome divided into stages, providing for a finer view of progress. In such embodiments, each stage can be subject to individual wagers in addition to or instead of wagers on the larger project.

Alternatively, different wagering opportunities can be offered to different entities. For example, coworkers receive the opportunity to wager on differing stages of the project. Such an embodiment can reduce the potential impact of intentional sabotage of the project, as well as reduce the chances of the same.

In one embodiment, techniques to conceal the identity of an individual's wagers are implemented. Such techniques may increase the honesty of wagers. While some association must be made between entity and wager (at least to pay the winners), limiting access to this association may improve overall results and performance. The associations can be hidden behind a wall, password protected, or the like.

The methods can be implemented over a computer network, with various steps taking place at any one or multiple nodes over the network. For example, communications can take place over a decentralized packet data network, such as the Internet, and can be encrypted for privacy and security. A graphical user interface can be provided.

In another embodiment, entities can update wagers and/or cast additional wagers at various times during the project. For example, new wagers can be made on a weekly basis, using additional wagering units. Alternatively, new wagers can be made daily, or monthly using additional wagering units. Any time span between wagers can be used, although it may be preferable to limit the intrusion on work by controlling the number of opportunities for wagering.

In one embodiment, each entity is asked at least one question when making a wager. For example, wagering may require identifying risks to the project, and/or identifying any information that may not be known, but should be, by management. Responses may be considered when identifying external factors, for example.

Using the teachings of this disclosure, it is apparent that a parimutuel betting system can be implemented in a project management context such that each participant in the project being managed may wager on the outcome of the project. Such a teaching differs from traditional parimutuel systems since each participant not only contributes to the determination of the outcome, but also wagers on it as well. Traditionally, contestants in a contest subject to wagers are prohibited from wagering on the contest, whereas these disclosures rely on the ‘contestant’ making the wagers.

While specific embodiments of the invention are disclosed herein, various changes and modifications can be made without departing from the spirit and scope of the invention.

What is claimed is:

1. A method for determining an award for at least one winner, the method comprising:
establishing at least a first outcome, the outcome predicated on a common output produced by a plurality of entities working in conjunction;
establishing at least three scenarios associated with the first outcome, each scenario associated with a condition of the first outcome;
receiving a plurality of wagers associated with each scenario and at least one of the entities; and
awarding at least a first award in a parimutuel basis based on the received wagers.

2. The method of claim 1 wherein establishing the scenarios comprises:
establishing at least the first award associated with the first outcome; and
presenting the established scenarios to the entities.

3. The method of claim 2 wherein awarding the first award comprises:
determining a result of the output;
comparing the determined result with the received wagers;
determining the at least one winner from the entities based on the comparison and the sum of the values associated with the winning wager;
establishing a pool based on the received wagers; and
awarding the first award based on the determined winner, wherein the first benefit is awarded based on the established pool and the determined winner.

4. The method of claim 1 wherein awarding the first award comprises:
determining a result of the output;
comparing the determined result with the received wagers;
determining the at least one winner from the entities based on the comparison and the sum of the values associated with the winning wager;
establishing a pool based on the received wagers; and
awarding the first award based on the determined winner, wherein the first benefit is awarded based on the established pool and the determined winner.

5. The method of claim 4 wherein establishing the scenarios comprises:
establishing at least a first award associated with the first outcome; and
presenting the established scenarios to the entities.

6. The method of claim 1 wherein receiving a plurality of wagers associated with each scenario and at least one of the entities comprises:
determining a pattern of the wagers;
determining a change in the pattern, wherein the change includes at least one inflection point;
associating the inflection point with at least one external factor;
modifying the external factor based on the inflection point.

7. The method of claim 6 wherein the determined change is associated with at least one statement received from the entity making the wager.

8. The method of claim 6 further comprising:
establishing at least a second outcome, the second outcome associated with an intermediate stage prior to attaining the first outcome, the second outcome predicated on a common output produced by the plurality of entities;
establishing at least three scenarios associated with the second outcome, each scenario associated with a condition of the second outcome;
receiving a plurality of wagers associated with each scenario and at least one of the entities; and
awarding at least a second award in a parimutuel basis based on the received wagers.

9. The method of claim 8 wherein the method further comprises:
associating at least one of the scenarios associated with the second outcome with at least one of the scenarios associated with the first outcome;
comparing received wagers based on the association; and
determining at least one inflection point based on the comparison.

10. The method of claim 9 further comprising:
determining at least one external factor based on the determined inflection point; and
controlling the at least one external factor.

11. The method of claim 1 wherein the outcome is based on a project, and wherein each of the scenarios relates to a result of the project.

12. A computer readable medium including computer readable code for determining an award for at least one winner, the computer readable code comprising:
computer readable code for establishing at least a first outcome, the outcome predicated on a common output produced by a plurality of entities working in conjunction;
computer readable code for establishing at least three scenarios associated with the first outcome, each scenario associated with a condition of the first outcome;
computer readable code for receiving a plurality of wagers associated with each scenario and at least one of the entities; and
computer readable code for awarding at least a first award in a parimutuel basis based on the received wagers.

13. The medium of claim 12 wherein establishing the scenarios comprises:
computer readable code for establishing at least the first award associated with the first outcome; and
computer readable code for presenting the established scenarios to the entities.

14. The medium of claim 13 wherein awarding the first award comprises:
computer readable code for determining a result of the output;
computer readable code for comparing the determined result with the received wagers;
computer readable code for determining the at least one winner from the entities based on the comparison and the sum of the values associated with the winning wager;
computer readable code for establishing a pool based on the received wagers; and
computer readable code for awarding the first award based on the determined winner, wherein the first benefit is awarded based on the established pool and the determined winner.

15. The medium of claim 14 wherein awarding the first award comprises:
computer readable code for determining a result of the output;
computer readable code for comparing the determined result with the received wagers;
computer readable code for determining the at least one winner from the entities based on the comparison and the sum of the values associated with the winning wager;
computer readable code for establishing a pool based on the received wagers; and
computer readable code for awarding the first award based on the determined winner, wherein the first benefit is awarded based on the established pool and the determined winner.

16. The medium of claim 12 wherein computer readable code for receiving a plurality of wagers associated with each scenario and at least one of the entities comprises:
computer readable code for determining a pattern of the wagers;
computer readable code for determining a change in the pattern, wherein the change includes at least one inflection point;
computer readable code for associating the inflection point with at least one external factor;
computer readable code for modifying the external factor based on the inflection point.

17. The medium of claim 16 wherein the determined change is associated with at least one statement received from the entity making the wager.

18. The medium of claim 16 further comprising:
establishing at least a second outcome, the second outcome associated with an intermediate stage prior to attaining the first outcome, the second outcome predicated on a common output produced by the plurality of entities;
establishing at least three scenarios associated with the second outcome, each scenario associated with a condition of the second outcome;
receiving a plurality of wagers associated with each scenario and at least one of the entities; and
awarding at least a second award in a parimutuel basis based on the received wagers.

19. The medium of claim 18 wherein the method further comprises:
associating at least one of the scenarios associated with the second outcome with at least one of the scenarios associated with the first outcome;
comparing received wagers based on the association; and
determining at least one inflection point based on the comparison.

20. A system for determining an award for at least one winner, the system comprising:
means for establishing at least a first outcome, the outcome predicated on a common output produced by a plurality of entities working in conjunction;
means for establishing at least three scenarios associated with the first outcome, each scenario associated with a condition of the first outcome;
means for receiving a plurality of wagers associated with each scenario and at least one of the entities; and
means for awarding at least a first award in a parimutuel basis based on the received wagers.
